(19) United States
(12) Patent Application Publication
(10) Pub. No.: US 2008/0054710 A1
(43) Pub. Date: Mar. 6, 2008

(54) Spoke nipple

(75) Inventors: Stephan Spahr, Lengnau (CH); Martin Walthert, Bern (CH)

Correspondence Address: GREER, BURNS & CRAIN, 300 S WACKER DR, 25TH FLOOR, CHICAGO, IL, 60606, US

(73) Assignee: DT SWISS INC.

(21) Appl. No.: 11/513,467

(22) Filed: Aug. 31, 2006

(51) Int. Cl. B60B 21/06

(52) U.S. Cl. 301/58

(57) ABSTRACT

A spoke nipple, particularly for bicycles and similar contrivances with a nipple body having a first end and a second end and a bore hole for receiving a spoke, wherein said bore hole is at least accessible from said first end of said nipple body, the bore hole having an internal thread for fastening the nipple to a spoke, a nipple head at the nipple body, wherein a tightening apparatus is arranged for rotating the spoke nipple with a tool around its longitudinal axis. The tightening apparatus includes a tightening cross-section with at least three protrusions protruding radially outwardly with respect to the tightening cross-section and recesses arranged between the protrusions wherein the protrusions are distributed in a circumferential direction of the tightening cross-section of the tightening apparatus and rounded at their respective tips and wherein the recesses are curved.

### BACKGROUND

The present invention relates to a spoke nipple which is particularly well suited for use on the wheel of a bicycle, wheelchair, or other such similar contrivances.

Furthermore the use of such spoke nipples is not solely limited to the wheels of bicycles; it is also possible to make use of such spoke nipples on the wheel of other types of single or multi-wheeled contrivances such as, for example, the wheels of a (bicycle) trailer or those on strollers and children's pushchairs. For reasons of simplification, the following description of the present invention will basically refer to its use on bicycle wheels, although this description does not in any way signify a restriction of the scope of the application.

Spoke nipples are customarily arranged on the rims of bicycle wheels for the purpose of securing the spokes. A spoke nipple is usually realized as a substantially cylindrical body having a protuberance at one end which may comprise a nipple head. When being mounted, one end of the spoke nipple is inserted from the outside into a hole in the rim which has a smaller diameter than the diameter of the nipple, respectively smaller than the diameter of the nipple head, so that the spoke nipple will be retained in the rim. An outer thread is disposed on the end of the spoke protruding radially outwardly from the hub, onto which the inner thread of the spoke nipple is screwed.

For the purpose of screwing the nipple on the spoke, the nipple head usually comprises a bolt head with a slot which cooperates with a screwdriver. In other embodiments the bolt head comprises a cross recess. In yet other embodiments the nipple body of the spoke nipple comprises a rectangular cross-section which can be gripped by an appropriate tool in order to fasten the nipple to the spoke.

These embodiments serve to secure the nipple to the spoke. However the nipples known from the state of the art have certain disadvantages. In some applications the user may wish to temporarily fix the nipple on the tool. With the nipple fixed on the tool it can be inserted more conveniently into a respective hole of the rim. The nipples known from the state of the art do not allow a temporary fixing on the respective tool, like a screwdriver, as it will easily drop off the screwdriver.

Moreover the torque, which can be applied to the nipples known from the state of the art is considerably low due to the respective nipple heads or nipple bodies. Especially in the case of slots in the nipple heads there is a significant danger for the screwdriver to slip off during the mounting process.

### SUMMARY

It is therefore the task of the invention to provide a spoke nipple, particularly for wheels such as on bicycles and other similar contrivances, which can more conveniently be mounted onto a spoke.

The spoke nipple according to the invention, particularly for bicycles and similar contrivances, comprises a nipple body with a first end and a second end and a bore hole for receiving a spoke, wherein said bore hole is at least accessible from the first end of said nipple body. Moreover the bore hole comprises an internal thread for fastening the nipple to a spoke. Furthermore the spoke nipple comprises a nipple head. A tightening means for rotating said spoke nipple with a tool around its longitudinal axis may be provided at the nipple body and/or at the nipple head. According to the invention the tightening means comprises a tightening cross-section with at least three protrusions protruding radially outwardly with respect to the tightening cross-section and recesses arranged between the protrusions wherein the protrusions are distributed in a circumferential direction of the tightening means and rounded at their respective tips and wherein the recesses are curved.

Preferably the spoke nipple is arranged substantially concentrically with respect to a longitudinal axis of the spoke nipple. Also the bore hole is preferably arranged substantially concentrically to the longitudinal axis of the spoke nipple. In another preferred embodiment the nipple head is formed one-piece with the nipple body.

The tightening cross-section is understood to be the section of the nipple to which forces are applied for example by a screwdriver or a wrench. The tightening cross-section may be formed as an inner cross-section which cooperates with a tool which is inserted into the cross-section. The tightening cross-section may also be formed as an outer cross-section, which cooperates with a tool that grips the tightening cross-section from the outside of the tightening cross-section. In the following description the inner cross-section will also be referred to as female and the outer cross-section will also be referred to as male. These aspects will be described into more detail with respect to the drawings.

In a preferred embodiment said at least three protrusions are shaped uniformly.

In a further preferred embodiment the tightening means comprises a cross-section with six protrusions protruding radially outwardly with respect to the tightening cross-section. Preferably said six protrusions are shaped uniformly and distributed uniformly in a circumferential direction of the spoke nipple.

In a preferred embodiment the tightening means comprises a cross-section with six protrusions protruding radially outwardly. Tightening means of this kind are known from the state of the art in connection with conventional screws under the trade mark Torx. These tightening means can exert an improved surface pressure. The tools which cooperate with the above mentioned spoke nipples are usually adapted to said spoke nipples.

One advantage of the spoke nipple according to the invention is the improved resistance with respect to applied torques since the contact area between the screwing tool and the nipple is enlarged and therefore improved. Also a transmission of higher forces is achieved.

Preferably the nipple body is configured substantially rotationally symmetric to the longitudinal axis of the spoke nipple and the axis of the thread coincides with said longitudinal axis.

In a further embodiment the tightening means is arranged at the nipple body or at the nipple head or both at the nipple body and the nipple head. The latter arrangement allows a more versatile use of the spoke nipple. If the tightening means according to the invention is arranged at the nipple head, the spoke nipple can be fixed temporarily on a screw driver or the like for placing the nipple into a rim bed.

In a further embodiment said tightening means has a star shaped pattern with a plurality of cams. These cams are formed to receive forces of a tool. In a further preferred embodiment the cams are inner cams and in another embodiment the cams are outer cams. Preferably between three and eight cams are provided.

In another preferred embodiment the bore hole is provided over the whole length and is therefore a through hole which is accessible from both ends of the spoke nipple. In a further preferred embodiment the inner diameter of the bore hole has a uniform diameter over the whole length.

In a further embodiment the bore hole has at least two sections with different inner diameters. Preferably a segment of the bore at the first end of said nipple body is provided with a larger diameter. This larger diameter allows the application of higher forces. In another preferred embodiment said segment of the bore is provided with a larger inner diameter than the outer diameter of the internal thread of the bore hole. This prevents a clamping or jamming of the spoke nipple when high forces are applied, since the effecting pressure may result in a small deformation of the first end of the nipple that is abutting the rim. If the inner thread is deformed a jamming of the spoke may occur resulting in a higher frictional resistance of the nipple and leading to inhomogeneous spoke tensions in a mounted wheel.

Preferably the tightening means is a female tightening means located at the end of the spoke nipple opposite of the spoke (i.e. the second end).

In a further embodiment of the invention the tightening means is a female tightening means located at the nipple head, wherein the outer diameter of the nipple head is smaller than the outer diameter of the nipple body. In this embodiment the spoke nipple in its entirety is arranged radially outwardly with respect to the rim body. This will be explained with reference to the drawings.

In a further preferred embodiment a nipple shaft is provided for passing through a hole in a rim and the nipple shaft has a smaller outer diameter than the outer diameter of the nipple body. In this embodiment preferably the nipple head prevents the nipple from passing completely through the hole in the rim.

In a further preferred embodiment the tightening means is a male (or outer) tightening means and preferably comprises a plurality of uniformly shaped cams. These uniformly shaped cams are preferably uniformly distributed in an circumferential direction of the spoke nipple. In another preferred embodiment the tightening cross-section of the tightening means is symmetrical with respect to a at least one or a plurality of symmetric axes and/or to at least one symmetric plane or to a plurality of symmetric planes.

In a further embodiment the tightening means is a female tightening means.

In a further embodiment the nipple head comprises a female (or inner) tightening means. Also, the nipple body in another embodiment comprises a male tightening means.

In another preferred embodiment the nipple body comprises a convexly curved end face. This end face allows an improved arrangement of the nipple in a rim.

In another preferred embodiment of the invention a quantity of glue is provided in the nipple hole, wherein said quantity of glue is furthermore so structured and arranged so as to be activated to function as an agent to secure the screw thread to a spoke while being screwed into said spoke nipple.

Preferably said quantity of glue is taken from a group of glues comprising single-, double- or multi-component glues, acrylic glues or acylate, synthetic or epoxy resins with the corresponding hardeners or other standard or similar glues. These embodiments are very advantageously used in connection with the nipples according to the invention because these nipples allow a higher torque to be applied and therefore the glues allow a more stable mounting of the spokes compared to the state of the art.

The present invention is also directed to a spoke for a bicycle with a spoke nipple according to the above description. Furthermore the invention is directed to a wheel for a bicycle and the like with a plurality of spoke nipples according to the above description and to a bike with a plurality of such formed spokes.

### BRIEF DESCRIPTION OF THE DRAWINGS

Further advantages, characteristics and possible applications of the present invention will now be described with respect to the embodiments and in reference to the drawings following drawings.

FIG. 1a is a side view of a spoke nipple according to the invention in a first embodiment;

FIG. 1b is a top view of the nipple head of the spoke nipple according to FIG. 1a;

FIG. 1c is a top view of the nipple body of the spoke nipple according to FIG. 1a;

FIG. 1d is a cross-sectional view of the spoke nipple according to FIG. 1a;

FIG. 1e is a perspective view of the spoke nipple according to FIG. 1a;

FIG. 2a is a side view of a spoke nipple according to the invention in a second embodiment;

FIG. 2b is a top view of the nipple head of the spoke nipple according to FIG. 2a;

FIG. 2c is a top view of the nipple body of the spoke nipple according to FIG. 2a;

FIG. 2d is a cross-sectional view of the spoke nipple according to FIG. 2a;

FIG. 2e is a perspective view of the spoke nipple according to FIG. 2a;

FIG. 3a is a side view of a spoke nipple according to the invention in a third embodiment;

FIG. 3b is a top view of the nipple head of the spoke nipple according to FIG. 3a;

FIG. 3c is a top view of the nipple body of the spoke nipple according to FIG. 3a;

FIG. 3d is a cross-sectional view of the spoke nipple according to FIG. 3a;

FIG. 3e is a perspective view of the spoke nipple according to FIG. 3a;

FIG. 4a is a side view of a spoke nipple according to the invention in a fourth embodiment;

FIG. 4b is a top view of the nipple head of the spoke nipple according to FIG. 4a;

FIG. 4c is a top view of the nipple body of the spoke nipple according to FIG. 4a;

FIG. 4d is a cross-sectional view of the spoke nipple according to FIG. 4a;

FIG. 4e is a perspective view of the spoke nipple according to FIG. 4a;

FIG. 4f is an enlarged view of an end face of the spoke nipple according to FIG. 4a;

FIG. 5a is a side view of a spoke nipple according to the invention in a fifth embodiment;

FIG. 5b is a top view of the nipple head of the spoke nipple according to FIG. 5a;

FIG. 5c is a top view of the nipple body of the spoke nipple according to FIG. 5a;

FIG. 5d is a cross-sectional view of the spoke nipple according to FIG. 5a;

FIG. 5e is a perspective view of the spoke nipple according to FIG. 5a;

FIG. 5f is an enlarged view of an end face of the spoke nipple according to FIG. 5a; and

FIG. 6 is an example of a spoke nipple according to the invention in a rim.

### DETAILED DESCRIPTION OF THE PREFERRED EMBODIMENT

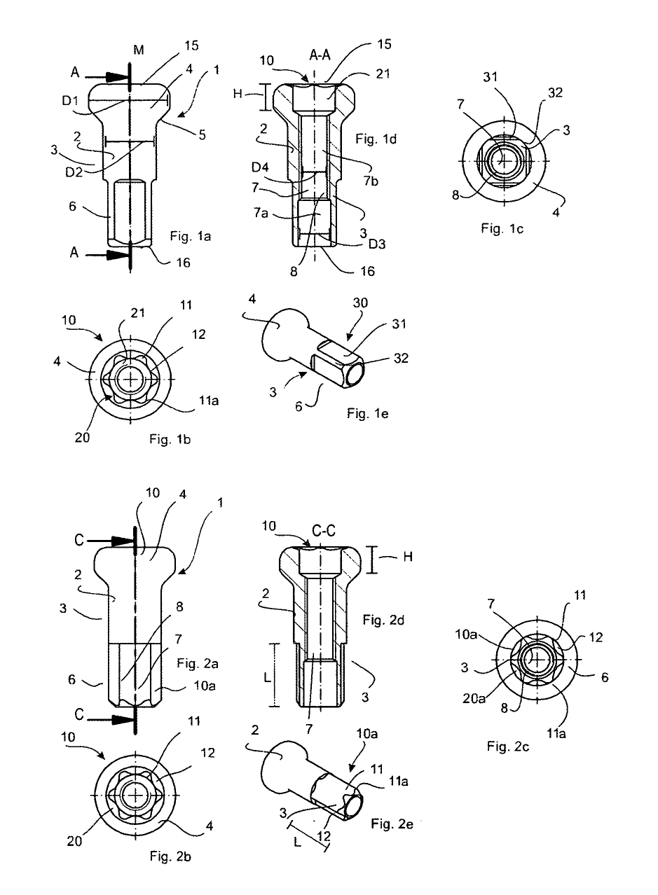

FIG. 1ashows a side view of a spoke nipple according to the invention in a first embodiment. The spoke nipple 1 comprises a nipple head 4 formed one-piece with a nipple body 3.

The diameter D1 of the nipple head 4 is larger than the diameter D2 of the nipple body 3. The reference symbol 5 refers to a transition region in which the larger diameter D1 of the nipple head 4 continuously decreases to the smaller diameter D2 of the nipple body 3. The nipple body 3 of the spoke nipple can be fit through a hole in a wheel rim, whereas the nipple head 4 will not pass through said hole.

Reference numeral 16 refers to a first end of the spoke nipple and reference numeral 15 to a second end of the spoke nipple 1. Reference numeral 7 refers to a bore hole which is accessible from the first end 16. The bore hole 7 is arranged concentrically with respect to a longitudinal axis M. Reference numeral 2 refers to a central portion of the spoke nipple 1.

FIG. 1b shows a top view of the nipple head 4 of the spoke nipple 1 according to FIG. 1a. The nipple head 4 comprises in the embodiment shown in FIG. 1b a tightening means 10. This tightening means 10 comprises a tightening cross-section 20 with six protrusions 11 arranged uniformly in the circumferential direction of the tightening means 10. As can be seen in FIG. 1b, the tips 11a of the protrusions 11 are curved. Between the tips 11arespective recesses 12 are arranged, wherein these recesses are curved.

The entire shape of the tightening means is also used for other contrivances, for example in the form of so-called torx screws. The tightening means 10 in this embodiment is a female or inner tightening means and may also be considered an internal torx. The respective curved protrusions 11 and recesses 12 allow higher torques to be applied when the tightening means 10 and hence the whole spoke nipple is rotated around axis M with a tool. The tool is inserted into a hole 21 which is formed in the nipple head 4.

The use of a female tightening means offers the advantage that a very tiny tool may be used to tighten the spoke nipple to a spoke. This tool may be inserted into the tightening means i.e. the hole 21 of the tightening head 4 from the outside with respect to the rim. It should be considered that the spokes of a wheel usually do not extend exactly in the radial direction of the wheel but in a direction which is inclined with respect to the plane of the rim. Therefore also the spoke nipples will align accordingly and the nipple heads are less accessible from the outside of the rim since the tool has to be introduced through the opening, as shown in FIG. 6.

In case of a female tightening means the tool can be introduced easily even if the spoke nipple is inclined with respect to the plane of the rim since the tool does not encompass the tightening means. In contrast thereto, for spoke nipples known from the state of the art the procedure of introducing the spoke nipples into the rim and tightening them with a screwdriver afterwards is a very demanding task due to the reasons mentioned above. In case of a male tightening means being used the positioning of a tool is even more difficult and is, since the opening in the rim bed is not large enough, sometimes even impossible.

Automation processes can be facilitated by the use of the spoke nipple according to the invention. For example automated screwing is simplified since the tool will not glide off the spoke nipple as in the case of a conventional spoke nipple with a conventional tightening means in the form of a slot at the nipple head.

FIG. 1c shows a top view of the nipple body of the spoke nipple according to FIG. 1a. In this embodiment, the spoke nipple 1 comprises a conventional tightening means at the outside of the nipple shaft 6 with four cams 31, being connected by four oblique sections 32 (see also FIG. 1e). Reference numeral 8 refers to an internal thread for tightening the spoke nipple to a spoke (not shown) by rotating the spoke nipple around axis M.

In the embodiment shown in FIG. 1d (a view along the line A-A of FIG. 1a), the bore hole 7 is a through hole passing from the first end 16 to the second end 15. In this embodiment the diameter D3 of the thread 8, which is arranged in a lower section 7a of the bore hole 7, is larger than the diameter D4 of the middle section 7b of the bore hole, but smaller than the above-mentioned diameters D1 and D2. The hole 21, into which a tool may be inserted, abuts against the middle section 7b of the bore hole 7.

FIG. 1e shows a perspective view of the spoke nipple according to FIG. 1a, illustrating the nipple head 4 and the nipple body 3. Reference numeral 30 refers to the conventional tightening means of the spoke nipple located at the nipple shaft 6.

FIG. 2ashows a further embodiment of the spoke nipple 1 according to the invention. In contrast to the spoke nipple 1 shown in FIG. 1athe spoke nipple shown in FIG. 2acomprises both a nipple head and a nipple body with a tightening means 10, 10a according to the invention.

Therefore FIG. 1b and FIG. 2b look identical to each other. The difference between the embodiment of FIGS. 1a-1e and the embodiment of FIGS. 2a-2e is explained with reference to FIG. 2c showing a top view of the nipple body according to FIG. 2a.

In this embodiment the tightening means 10a arranged at the nipple shaft 6 of the nipple body 3 of the spoke nipple 1 comprises a cross-section 20a with six protrusions 11 and six recesses 12 arranged between them. The tightening means 10a arranged at the nipple shaft 3 in this embodiment is a male tightening means. The tightening means 10a may be clamped at the nipple body 3 with a clamping tool like a wrench, especially a wrench suitable for torx screws and be rotated around the axis M. Also in this embodiment the surface pressure can be increased. The tips 11aof the protrusions 11 are also rounded. Both the recesses 12 and the protrusions 11 extend along line L shown in FIGS. 2d and 2e respectively.

Both in the embodiment shown in FIGS. 1a-1e and in the embodiment shown in FIGS. 2a-2e the nipple head 4 is arranged radially outwardly with respect to the rim bed whereas the nipple body 3 is arranged radially inwardly with respect to the rim bed (not shown), when mounted to a rim.

The bore holes 7 and threads 8 of the spoke nipples shown in FIGS. 1a-1e and in FIGS. 2a-2e respectively correspond to each other.

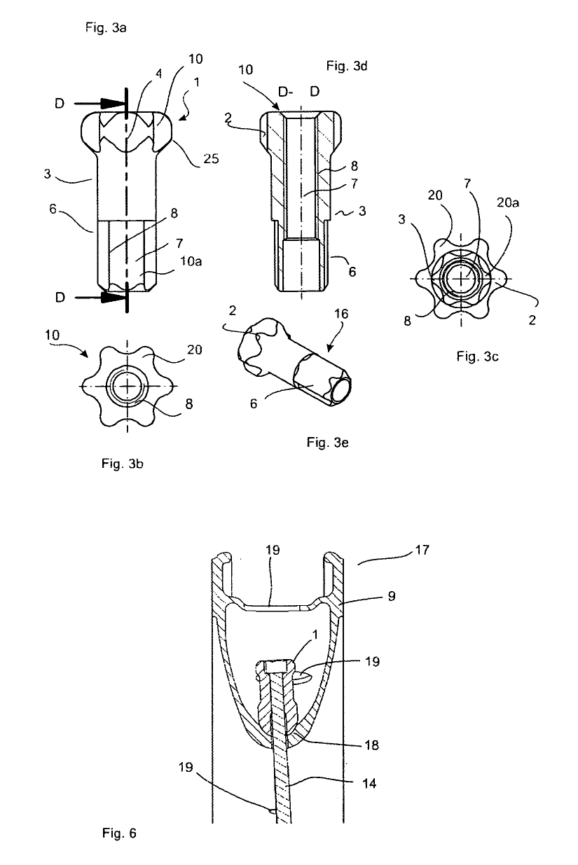

FIGS. 3a-3e show another embodiment of the spoke nipple 1 according to the invention. In this embodiment both the nipple head 4 and the nipple body 3 comprise male tightening means 10, 10a. The spoke nipple 1 according to this embodiment may thus be rotated by an appropriate tool both from the inside and from the outside of the rim (not shown).

One advantage of a spoke nipple using a male tightening means according to the invention is that the entire spoke nipple may be designed shorter since no space has to be provided for inserting a tool into a tightening means like the hole 21 in case of the embodiment shown in FIGS. 1a-1e, where an additional length H is needed for the tightening section in the nipple head. A spoke nipple with a female tightening means in contrast requires higher lengths, as can be seen from FIGS. 1d and 2d.

The nipple head shown in FIG. 3a and FIG. 3e comprises a rounded or spherical surface 25, as can be seen in the side view of FIG. 3a. This spherical surface 25 allows to apply a tool in an inclined direction while maintaining a gripping around the entire nipple head i.e. around the entire circumference of the nipple head 4. This embodiment is especially convenient for male tightening means and accommodates the tightening process. The tightening means 10 at the nipple head 4 may also comprise both a male tightening means and a female tightening means with a smaller diameter in case of the female tightening means.

FIG. 3c shows a top view of the nipple body of the spoke nipple according to FIG. 3a. As can be seen in FIG. 3c, both the nipple head 4 and the nipple shaft 6 comprise a male or outer tightening means 10, 10a with respective tightening cross-sections 20, 20a, wherein the diameter of the nipple body's tightening means is smaller than the diameter of the nipple head's tightening means 10. Apart from the difference in size, both tightening means are substantially identical in shape. Also in this embodiment the bore hole 7 is formed as a through hole.

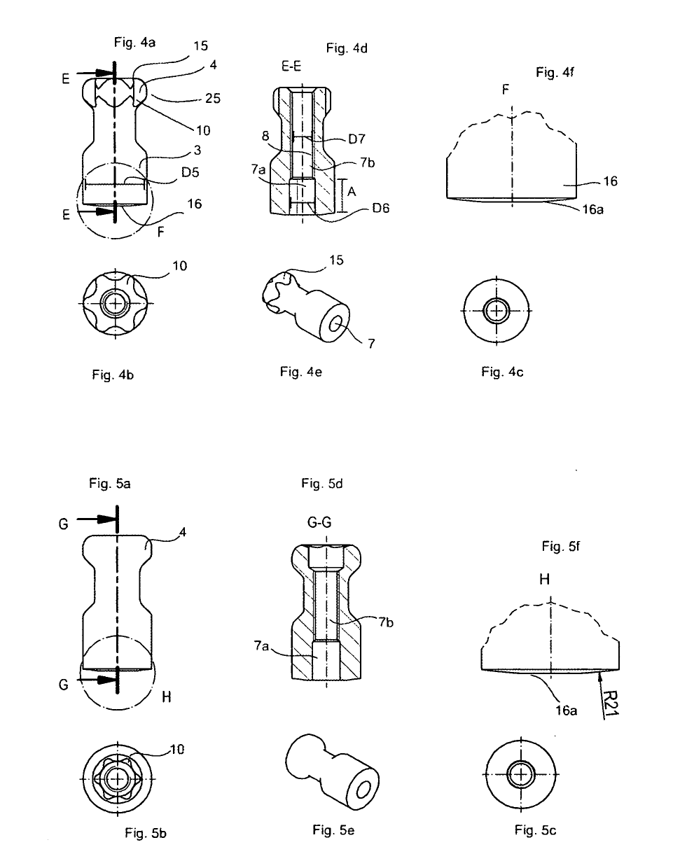

FIGS. 4a-4f show another embodiment of a spoke nipple according to the invention. In this embodiment the spoke nipple comprises a nipple head 4 with a male tightening means 10 according to the invention. The nipple body comprises an enlarged diameter D5 which does not pass through the holes of the rim. Therefore in this embodiment, the entire spoke nipple 1 is arranged radially outwardly with respect to the rim bed, as is also depicted in FIG. 6.

The nipple head shown in FIG. 4a and FIG. 4e comprises a spherical surface 25, so that it is possible to apply a tool in an inclined direction with respect to the longitudinal axis M of the spoke nipple. At the same time a perfect grip is maintained around the entire nipple head, i.e. around the entire circumference of the nipple head 4. Therefore even male tightening means can be easily used when screwing a spoke nipple according to this embodiment.

The bore hole 7 comprises a lower unthreaded section 7a and a middle threaded section 7b comprising an internal thread 8 (see FIG. 4d). Therefore the thread 8 does extend through the complete spoke nipple but ends at a predetermined distance A before the first end 16 of the spoke nipple 1. This first end 16 contacts the rim bed in a mounted state, as shown in FIG. 6. The inner diameter D6 of the lower unthreaded section 7a is preferably larger than the diameter D7 of the middle threaded section 7b. In this embodiment the nipple body 3 does not comprise a tightening means according to the invention.

If a spoke mounted to the spoke nipple shown in FIGS. 4a-4f is tensioned, a high pressure will be applied to the spoke nipple 1. This pressure will induce a slight deformation at the first end 16 of the nipple body 1. If the thread 8 extended to the first end 16, this deformation would cause the material of the spoke nipple 1 to apply pressure forces on the thread, and a rotation of the spoke with respect to the spoke nipple 1 would be complicated since the torque necessary to rotate the spoke with respect to the spoke nipple 1 would be increased.

By the above-mentioned embodiment i.e. the thread not extending through the complete hole and the increased diameter of the lower unthreaded section 7a , a facile rotation of the spoke nipple 1 is ensured even in case of a deformation of the material of the spoke nipple. Therefore a desired higher tension may be applied onto the spoke, since an additional torque load acting on the spoke is avoided.

FIG. 4f shows an enlarged view of the first end 16 of the spoke nipple 1 i.e. the portion of the spoke nipple 1 which can be found in circle F of FIG. 4a.

In this embodiment the first end 16 of the spoke nipple 1 comprises a curved surface 16a. The radius of curvature of the curved surface is adapted to the shape of the rim bed on which the spoke nipple is located. Therefore an inclined alignment of the spoke nipple 1 will be facilitated when the spoke nipple is tightened to a spoke. Therefore the spoke nipple can align ideally with respect to the rim bed while maintaining an optimized position (or fixing) with respect to the rim.

FIGS. 5a to 5f show another embodiment of the spoke nipple according to the invention. The difference between the spoke nipple shown in FIGS. 4a-4f and the spoke nipple shown in FIGS. 5a-5f is that in case of the spoke nipple according to FIGS. 5a-5f a female tightening means is used at the nipple head 4, whereas in FIGS. 4a-4f a male tightening means according to the invention is used. The spoke bodies are equally shaped in FIGS. 5a-5f and FIGS. 4a-4f respectively.

In both embodiments shown in FIGS. 4a-5f a uniform cylindrical shape of the spoke nipple 1 could also be used.

FIG. 6 shows a part of a wheel 17 comprising a rim 9 and spoke nipple 1 connected to a spoke 14. The spoke nipples are introduced from the outside of the rim through holes 19 and abut the contacting area of the rim bed 18 of the rim 9. The first end of the spoke nipple may comprise a curved surface 16a as shown in FIGS. 4f and 5f to enable the spoke nipple to align with the direction of the spoke 14.

What is claimed is:

1. A spoke nipple, particularly for bicycles and similar contrivances, comprising: a nipple body having a first end and a second end and a bore hole for receiving a spoke, wherein said bore hole is at least accessible from said first end of said nipple body,
the bore hole having an internal thread for fastening the nipple to a spoke, a nipple head at the nipple body, wherein a tightening means is arranged for rotating the spoke nipple with a tool around its longitudinal axis,
the tightening means comprises a tightening cross-section with at least three protrusions protruding radially outwardly with respect to the tightening cross-section and recesses arranged between the protrusions wherein the protrusions are distributed in a circumferential direction of the tightening cross-section of the tightening means and rounded at their respective tips and wherein the recesses are curved.

2. The spoke nipple according to claim 1, wherein said nipple head is formed one-piece with said nipple body.

3. The spoke nipple according to claim 1, wherein the bore hole is arranged substantially concentrically to a longitudinal axis of the spoke nipple.

4. The spoke nipple according to claim 1, wherein said at least three protrusions are shaped uniformly.

5. The spoke nipple according to claim 1, wherein the tightening means comprises a cross-section with six protrusions protruding radially outwardly with respect to the tightening cross-section.

6. The spoke nipple according to claim 1, wherein the tightening means is arranged at the nipple body.

7. The spoke nipple according to claim 1, wherein the tightening means is arranged at the nipple head.

8. The spoke nipple according to claim 1, wherein one tightening means is arranged at the nipple head and one tightening means is arranged at the nipple body.

9. The spoke nipple according to claim 1, wherein said tightening means has a star shaped pattern with a plurality of cams.

10. The spoke nipple according to claim 9, wherein the cams are inner cams.

11. The spoke nipple according to claim 9, wherein the cams are outer cams.

12. The spoke nipple according to claim 9, wherein between three and eight cams are provided.

13. The spoke nipple according to claim 1, wherein the bore hole is provided over the whole length.

14. The spoke nipple according to claim 13, wherein the inner diameter of the bore hole is uniform.

15. The spoke nipple according to claim 13, wherein the bore hole has at least two sections with different inner diameters.

16. The spoke nipple according to claim 15, wherein a segment of the bore hole at the first end of said nipple body is provided with a larger diameter.

17. The spoke nipple according to claim 16, wherein said segment of the bore is provided with a larger inner diameter than the outer diameter of the internal thread.

18. The spoke nipple according to claim 13, wherein the tightening means is a female tightening means located at the end of the spoke nipple opposite the spoke.

19. The spoke nipple according to claim 13, wherein the tightening means is a female tightening means located at the nipple head, and wherein the outer diameter of the nipple head is smaller than the outer diameter of the nipple body.

20. The spoke nipple according to claim 13, wherein a nipple shaft is provided for passing through a hole in a rim and wherein the nipple shaft has a smaller outer diameter than the outer diameter of the nipple body.

21. The spoke nipple according to claim 1, wherein the tightening means is a male tightening means.

22. The spoke nipple according to claim 21, wherein the tightening means comprises a plurality of uniformly shaped cams.

23. The spoke nipple according to claim 22, wherein the uniformly shaped cams are uniformly distributed in a circumferential direction of the spoke nipple.

24. The spoke nipple according to claim 21, wherein the tightening cross-section of the tightening means is symmetrical with respect to at least one symmetric plane.

25. The spoke nipple according to claim 1, wherein the tightening means is a female tightening means.

26. The spoke nipple according to claim 1, wherein the nipple head comprises a female tightening means.

27. The spoke nipple according to claim 1, wherein the nipple body comprises a male tightening means.

28. The spoke nipple according to claim 1, wherein the nipple body comprises a convexly curved end face.

29. The spoke nipple according to claim 1, wherein a quantity of glue is provided in the bore hole so as to be activated to function as an agent to secure the screw thread to a spoke while being screwed into said spoke nipple.

30. A wheel for a bicycle and the like, comprising: a hub and a rim and a plurality of spoke nipples and of spokes, wherein each spoke nipple comprises a nipple body and a nipple head and wherein each spoke nipple is mounted to a spoke for connecting the hub to the rim, wherein each nipple body has a first end and a second end and a bore hole, wherein a spoke is mounted to each spoke nipple for connecting the hub with the rim, wherein said bore hole of said spoke nipple is at least accessible from said first end of said nipple body,
wherein the bore hole has an internal thread for fastening the nipple to the spoke, wherein a tightening means is arranged for rotating the spoke nipple with a tool around its longitudinal axis,
the tightening means of the spoke nipple comprises a tightening cross-section with at least three protrusions protruding radially outwardly with respect to the tightening cross-section and recesses arranged between the protrusions, wherein the protrusions are distributed in a circumferential direction of the tightening cross-section of the tightening means and rounded at their respective tips and wherein the recesses are curved.

31. A bicycle comprising: at least one wheel, wherein the wheel comprises a hub and a rim and a plurality of spoke nipples and of spokes, wherein each spoke nipple comprises a nipple body and a nipple head and wherein each spoke nipple is mounted to a spoke for connecting the hub to the rim, wherein each nipple body has a first end and a second end and a bore hole, wherein a spoke is mounted to each spoke nipple for connecting the hub with the rim, wherein the said bore hole of said spoke nipple is at least accessible from said first end of said nipple body,
wherein the bore hole has an internal thread for fastening the nipple to the spoke, wherein a tightening means is arranged for rotating the spoke nipple with a tool around its longitudinal axis,
the tightening means of the spoke nipple comprises a tightening cross-section with at least three protrusions protruding radially outwardly with respect to the tightening cross-section and recesses arranged between the protrusions, wherein the protrusions are distributed in a circumferential direction of the tightening cross-section of the tightening means and rounded at their respective tips and wherein the recesses are curved.
